(19) United States
(12) Patent Application Publication
(10) Pub. No.: US 2015/0052478 A1
(43) Pub. Date: Feb. 19, 2015

(54) METHOD AND APPARATUS FOR DISPLAYING A VISUAL ITEM

(71) Applicant: Samsung Electronics Co., Ltd., Gyeonggi-do (KR)

(72) Inventor: Jin Park, Gyeonggi-do (KR)

(21) Appl. No.: 14/310,953

(22) Filed: Jun. 20, 2014

(30) Foreign Application Priority Data
Aug. 16, 2013 (KR) 10-2013-0097299

(51) Int. Cl. G06F 3/0482

(52) U.S. Cl. CPC G06F 3/0482
USPC 715/810

(57) ABSTRACT

There are provided a method and apparatus for displaying a visual item in an electronic device. The method of displaying a visual item in an electronic device includes: displaying a visual item of a plurality of visual items; if a first input is received from a user, selecting one or more visual items of the plurality of visual items based on preferences of each of the visual items; and displaying a visual item of the selected visual items. Accordingly, it is possible to quickly determine a visual item to which a jump is to be made.

### CROSS-REFERENCE TO RELATED APPLICATION(S) AND CLAIM OF PRIORITY

The present application is related to and claims the benefit under 35 U.S.C. §119(a) of a Korean patent application filed on Aug. 16, 2013 in the Korean Intellectual Property Office and assigned Serial No. 10-20130097299, the entire disclosure of which is hereby incorporated by reference.

### TECHNICAL FIELD

The present disclosure relates generally to a method and apparatus for displaying a visual item in an electronic device.

### BACKGROUND

Various methods for providing visual items such as images or text in an electronic device have been developed. One of methods for providing such visual items is a flow-type display method.

For example, as illustrated in an example of FIG. 1 in which album jackets are displayed in the form of images on a screen of an electronic device, there is a method of locating one of album jackets arranged in a specific order in the center of a screen, and displaying the remaining album jackets around the album jacket.

In the example of FIG. 1, if a user performs a swipe operation in one direction in order to randomly access an album or to jump to a desired album, the electronic device can rearrange items to be displayed based on a velocity or a distance at which or to which the swipe operation has been performed.

Also, there is a method of determining the number of items over which a jump occurs based on the number of fingers used in a swipe operation or based on a time period taken for a long touch operation performed before a swipe operation.

However, these methods have a problem in that many inputs are required for a user to find his/her desired visual item or that a jump distance to a desired visual item may be wrongly calculated.

The above information is presented as background information only to assist with an understanding of the present disclosure. No determination has been made, and no assertion is made, as to whether any of the above might be applicable as prior art with regard to the present disclosure.

### SUMMARY

To address the above-discussed deficiencies, it is a primary object to provide a method for displaying a visual item in consideration of a user's intention.

For example, an embodiment of the present disclosure is to provide a method of determining a visual item to which a jump is to be made in consideration of a user's intention.

In accordance with an aspect of the present disclosure, there is provided a method of displaying a visual item in an electronic device. The method includes that a visual item of a plurality of visual items is displayed. If a first input is received from a user, one or more visual items of the plurality of visual items are selected based on preferences of each of the one or more visual items. The method also includes that a visual item of the selected visual items is displayed.

In accordance with another aspect of the present disclosure, there is provided an apparatus configured to display a visual item in an electronic device. The apparatus includes an input unit configured to receive an input from a user. The apparatus also includes a display unit configured to display a visual item. The apparatus further includes a controller configured to display, if a predetermined request is received, a visual item of a plurality of visual items, and to select, if a first input is received from a user, one or more visual items of the plurality of visual items based on preferences of each of the one or more visual items. The controller is also configured to display a visual item of the selected visual items.

Other aspects, advantages, and salient features of the disclosure will become apparent to those skilled in the art from the following detailed description, which, taken in conjunction with the annexed drawings, discloses exemplary embodiments of the disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a view for describing a visual item display method;

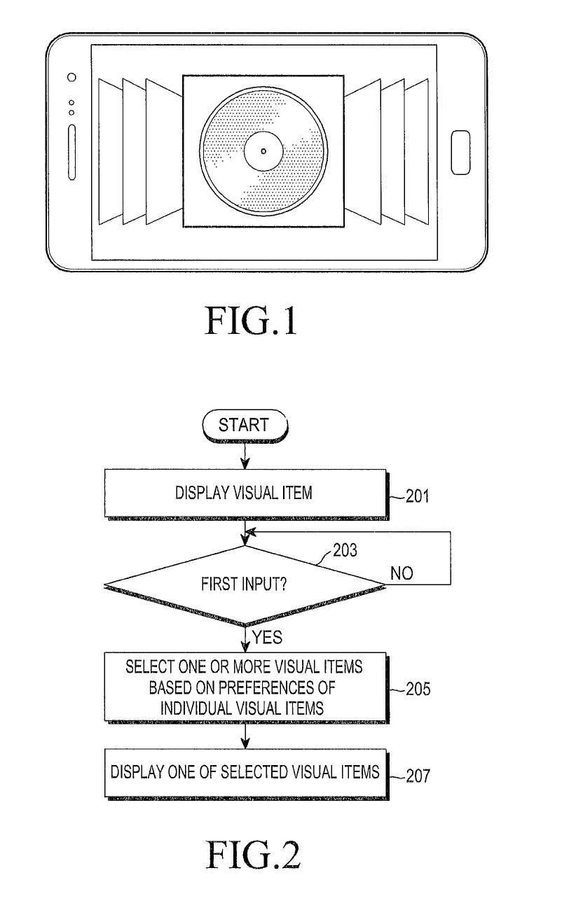

FIG. 2 is a flowchart of a visual item display method according to an exemplary embodiment of the present disclosure;

FIGS. 3A to 3C illustrate views for describing a visual item display method according to an exemplary embodiment of the present disclosure;

FIG. 4 is a flowchart of a preference setting method according to an exemplary embodiment of the present disclosure;

FIG. 5 illustrates a view for describing preferences stored in a server, according to an exemplary embodiment of the present disclosure; and

FIG. 6 illustrates a block diagram for describing an electronic device according to exemplary embodiments of the present disclosure.

Throughout the drawings, like reference numerals will be understood to refer to like parts, components, and structures.

### DETAILED DESCRIPTION

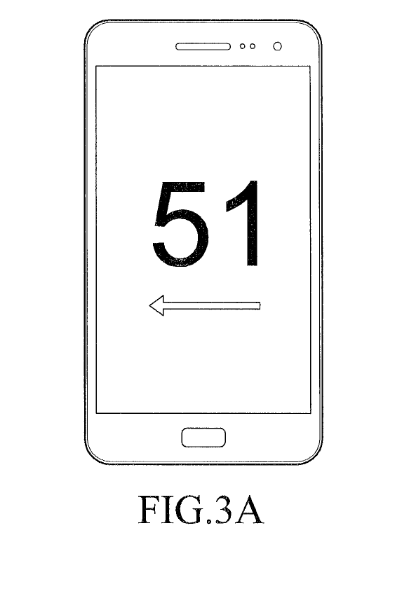

FIGS. 2 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device. The following description with reference to the accompanying drawings is provided to assist in a comprehensive understanding of exemplary embodiments of the disclosure as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the disclosure. Accordingly, it should be apparent to those skilled in the art that the following description of exemplary embodiments of the present disclosure is provided for illustration purposes only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the singular forms “a”, “an” and “the” are intended to include the plural forms as well, unless the context clearly indicates otherwise.

FIG. 2 is a flowchart of a visual item display method according to an exemplary embodiment of the present disclosure.

In step 201, an electronic device displays visual items, and then proceeds to step 203. In various embodiments of the present disclosure, the visual items may be objects including at least one of, for example, text, an image, or a moving image. The visual items may be displayed according to a request from a user. For example, if a user input for executing an electronic book application is received, the electronic device may display a list of electronic books, or a specific page of an electronic book to which a subscription has been lately made.

In step 203, the electronic device determines whether a first input has been received from the user, and if the electronic device determines that a first input has been received from the user, the electronic device proceeds to step 205. In various embodiments of the present disclosure, the first input may be an input set to jump from a visual item displayed currently on a screen to another visual item. For example, if a currently displayed visual item is a page of an electronic book, and an input set to display the next page or the previous page is a single touch operation, the first input may be a swipe operation.

In step 205, the electronic device selects one or more visual items from the visual items based on preferences of the individual visual items, and then proceeds to step 207. In various embodiments of the present disclosure, the preferences may be criterion for selecting a visual item to which a jump is to be made according to a first input. For example, the preferences may include at least ones of exposure times (such as time periods for which the respective visual items have been displayed) of the respective visual items, count values (such as numbers of times which the respective visual items have been displayed) of the respective visual items, and predetermined weights (such as values set in advance by an item designeror the like). The exposure times and count values may be calculated by the electronic device or by another electronic device,

In step 207, the electronic device displays one of the selected visual items.

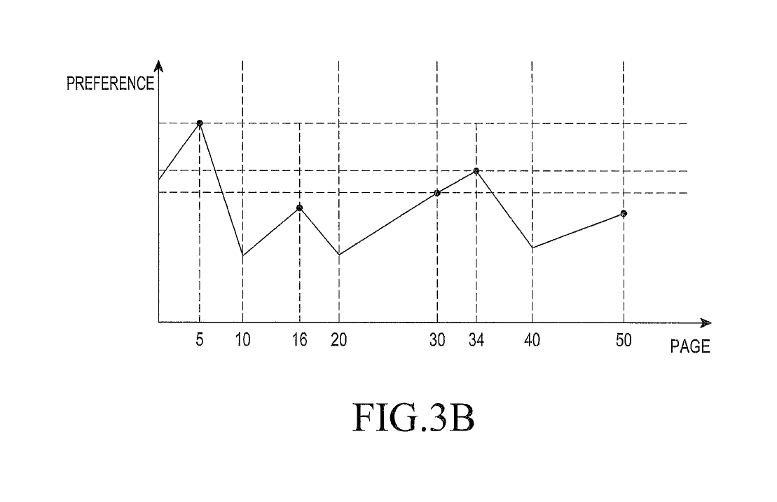

FIGS. 3A to 3C illustrate views for describing a visual item display method according to an exemplary embodiment of the present disclosure.

FIG. 3A relates to an example in which an electronic book is displayed in an electronic device. In FIG. 3A, it is assumed that an input set to move to a next page or a previous page is a single touch operation, and a first input set for an item jump is a swipe operation.

In this case, if a user performs a swipe operation in one direction, the electronic device selects one or more visual items based on preferences of the visual items, for example, based on preferences of individual pages constituting the electronic book.

According to an embodiment, the visual items may be selected based on a direction corresponding to the first input. For example, if a swipe operation is performed to the left, visual items may be selected from among the previous pages. In contrast, if a swipe operation is performed to the right, visual items may be selected from among the next pages.

According to an embodiment, visual items may be selected from among all visual items. For example, as illustrated in FIG. 3A, when a total number of pages of an electronic book currently displayed is 51, visual items may be selected from among the 1^{st} to 50^{th} pages. If three visual items have been set to be selected, the electronic device may select three pages from among the 1^{st} to 50^{th} pages in the order of higher preferences. This will be described in more detail with reference to FIG. 3B as follows. FIG. 3B illustrates a graph for describing preferences of the individual pages. As in the example of FIG. 3A, it is assumed that three visual items have been set to be selected from among all pages. In this case, the electronic device may select three pages (e.g., a 5^{th} page, a 30^{th} page, and a 34^{th} page) having higher preferences from among the 1^{st} to 50^{th} pages.

According to an embodiment, visual items may be selected based on a section including a predetermined number of visual items. For example, in the example of FIG. 3A in which a total number of pages of an electronic book currently displayed is 51, visual items may be selected from each of a plurality of sections, for example, a section from the 1^{st} to 10^{th} pages, a section from the 11^{th} to 20^{th} pages, a section from the 21^{st} to 30^{th} pages, a section from the 31^{st} to 40^{th} pages, and a section from the 41^{st} to 50^{th} pages. According to at least this embodiment, it can be assumed that one visual item has been set to be selected from each section. In this case, the electronic device may select a page having a highest preference from each section. Referring to FIG. 3B, the electronic device may select pages having highest preferences, for example, the 5^{th} page, the 16^{th} page, the 30^{th} page, the 34^{th} page, and the 50^{th} page from the respective sections.

After the visual items are selected, the electronic device may display one of the selected visual items.

According to an embodiment, the electronic device may display a visual item based on item distances. The item distances may be distances between items classified according to predetermined criteria. In an electronic book, item distances may be intervals between pages. For example, an item distance between a 51^{st} page and a 50^{th} page is 1, and an item distance between a 51^{st} page and a 40^{th} page is 11. In the current example, if a currently displayed page is the 51^{st} page, and selected pages are the 5^{th}, 30^{th}, and 34^{th} pages, the electronic device may display the 34^{th} page having a shortest item distance to the currently displayed page.

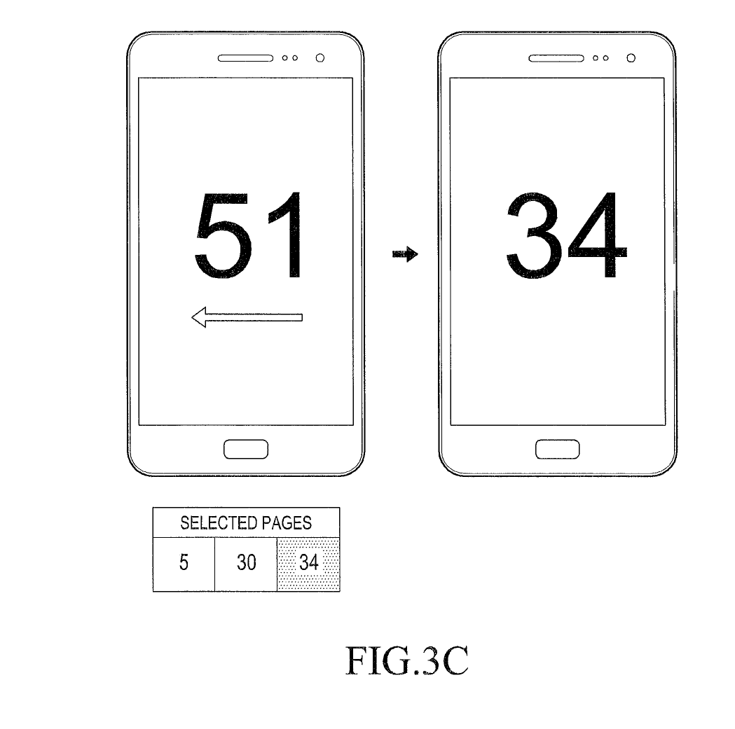

FIG. 4 illustrates a flowchart of a preference setting method according to an exemplary embodiment of the present disclosure.

In step 401, an electronic device displays a visual item, and then proceeds to step 403. The visual item may be displayed according to a request from a user.

In step 403, the electronic device drives or starts a timer, and then proceeds to step 405. The timer may be used to determine a time period for which the visual item is displayed.

In step 405, the electronic device increases a count value, and then proceeds to step 407. The count value may be used to determine the number of times which the currently displayed visual item has been displayed.

In step 407, the electronic device determines whether an input requesting the displaying of the next visual item has been received, and if the electronic device determines that an input requesting the displaying of the next visual item has been received, the electronic device proceeds to step 409.

In step 409, the electronic device accumulates and stores a timer value and the count value, and then, proceeds to step 401 to display the next visual item. The timer value and the count value may be accumulated and stored for each visual item. For example, the electronic device may accumulate and store the timer value and the count value to correspond to identification information of each visual item. The identification information may be a page ID of an electronic book.

The exemplary embodiment illustrated in FIG. 4 relates to a case of using both an exposure time and a count value. However, only an exposure time or only a count value may be used.

According to an exemplary embodiment, preferences calculated by an electronic device may be uploaded in a server so that the preferences can be used by other electronic devices.

For example, when an electronic device A has initially downloaded a new electronic book, no preference about the corresponding electronic book may be stored in the electronic device A. In this case, the electronic device A may download and use preferences about the electronic book, calculated by other electronic devices. The preferences about the electronic book may be downloaded in the electronic device A when the electronic book is initially downloaded.

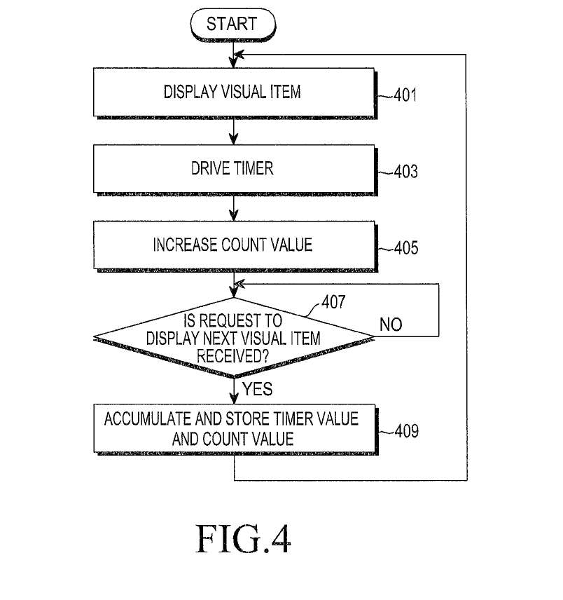

This operation will be described with reference to FIG. 5 as follows.

FIG. 5 illustrates a view for describing preferences stored in a server, according to an exemplary embodiment of the present disclosure.

An electronic device 510 may display an electronic book according to an input from a user, and simultaneously calculate a preference of each page. This operation has been at least similarly described above with reference to FIG. 4. The preference of each page may include at least one of an identification (ID) of the page of the corresponding electronic book, an exposure time corresponding to the ID of the page, a count value corresponding to the ID of the page, or a page jump unit that is used for a page jump. The page jump unit may be a section including a predetermined number of pages, which has been at least similarly described above with reference to FIG. 3.

The preference of each page may be stored in a server 520. According to an embodiment, the preference of each page may be stored in the server 520 when an electronic book application terminates.

If a request from another electronic device, for example, an electronic device 530 is received, the server 520 may transmit stored preferences to the electronic device 530. According to an embodiment, when a request for downloading a specific electronic book is received from the electronic device 530, the server 520 may automatically transmit stored preferences to the electronic device 530. According to an embodiment, whenever a specific application, for example, an electronic book application is executed in the electronic device 530, the server 520 may transmit stored preferences to the electronic device 530.

The electronic device 530, which has downloaded the preferences about the corresponding electronic book from the server 520, may make a page jump based on the downloaded preferences about the electronic book.

According to an embodiment, the preferences may include predetermined weights. For example, if a producer of the corresponding electronic book has highlighted a specific page or allocated importance to a specific page, it can be considered that the corresponding page has been allocated a weight.

Accordingly, when the electronic device which has downloaded an electronic book including at least one page to which a weight has been allocated has received a first input set for a page jump, the electronic device may make a page jump based on the corresponding weight. For example, the electronic device may make a page jump to the page to which the weight has been allocated.

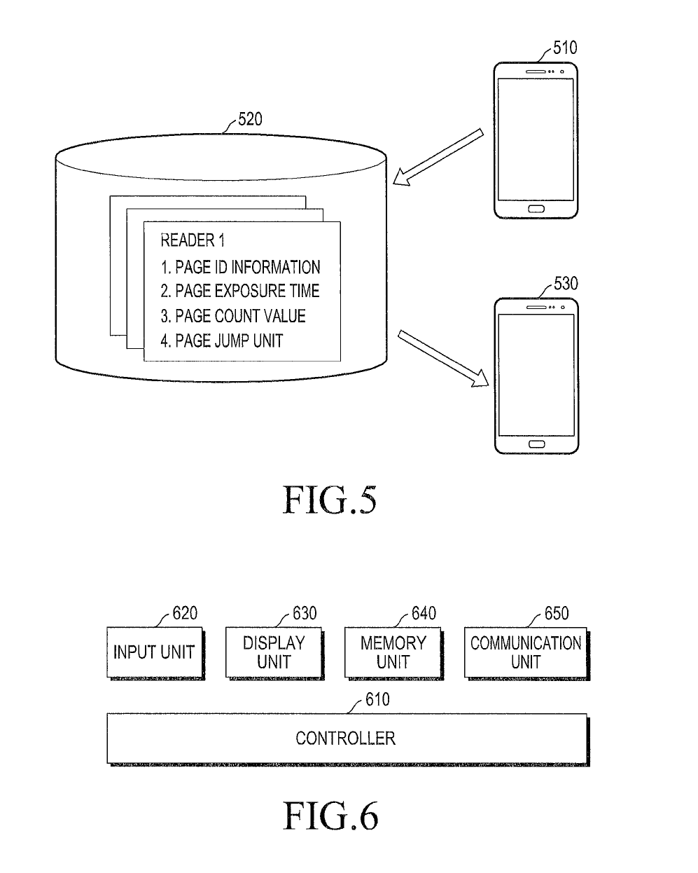

FIG. 6 illustrates a block diagram for describing an electronic device according to exemplary embodiments of the present disclosure. In an embodiment, at least one of components illustrated in FIG. 6 may be omitted.

Referring to FIG. 6, the electronic device may include a controller 610, an input unit 620, a display unit 630, a memory unit 640, and a communication unit 650.

If a predetermined request is received, the controller 610 may be configured to output one of a plurality of visual items through the display unit 630.

For example, if a first input is received through the input unit 620, the controller 610 may be configured to select one or more visual items from among a plurality of visual items based on preferences of the individual visual items. The controller 610 may be configured to select a predetermined number of visual items from among the plurality of visual items in the order of higher preferences. The controller 610 may also be configured to classify the plurality of visual items into a predetermined number of sections, and to select a predetermined number of visual items in the order of higher preferences in each of the classified sections.

The controller 610 may be configured to display one of the selected visual items. The controller 610 may be configured to display a visual item located in a direction corresponding to the first input among the selected visual items. Alternatively, the controller 610 may be configured to display a visual item located closest to a currently displayed visual item among the selected visual items. The preferences may be calculated based on time periods for which the respective visual items have been displayed, based on the numbers of times which the respective visual items have been displayed, or based on predetermined weights that have been allocated to the respective visual items.

The controller 610 may be configured to download the preferences of the visual items from an external device through the communication unit 650. The downloaded preferences of the visual items may have been calculated by another electronic device.

The input unit 620 may be configured to receive an input from a user.

The display unit 630 may be configured to display visual items. The input unit 620 and the display unit 630 may be implemented as a touch screen.

The memory unit 640 may be configured to store the preferences of the visual items.

The communication unit 650 may be configured to communicate with an external device through one of various communication methods. The external device may be a server configure to store the preferences of the visual items.

The above description relates to an example of an electronic book, however, various embodiments of the present disclosure may be applied to display various types of visual items. For example, various embodiments of the present disclosure may be applied to an interface such as an online store in which visual items are arranged based on a flow.

The embodiments of the present disclosure as described above may be implemented in various methods. For example, the embodiments of the present disclosure may be implemented as hardware, software, or a combination of hardware and software. The software may be executed on one or more processors using various Operating Systems (OSs) or platforms. The software may be created using an arbitrary one of a plurality of appropriate programming languages, and compiled to a machine-language code or an intermediate code that is executed on a framework or a virtual machine.

In addition, when the embodiments of the present disclosure are executed on one or more processors, the embodiments may be implemented as a processor-readable medium (e.g., a memory, a floppy disk, a hard disk, a compact disk, an optical disk, or a magnetic tape) in which one or more programs for performing methods for implementing the embodiments have been stored.

Therefore, according to the embodiments of the present disclosure as described above, it is possible to quickly determine a visual item to which a jump is to be made. Also, it is possible to determine a visual item to which a jump is to be made in consideration of a user's interest.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method of displaying a visual item in an electronic device, the method comprising:
displaying at least one visual item of a plurality of visual items;
if a first input is received from a user, selecting one or more visual items of the plurality of visual items based on preferences of each of the plurality of visual items; and
displaying at least one visual item of the selected visual items.

2. The method of claim 1, wherein selecting the one or more visual items comprises selecting a predetermined number of visual items of the plurality of visual items in an order of higher preferences.

3. The method of claim 1, wherein selecting the one or more visual items comprises:
classifying the plurality of visual items into a predetermined number of sections; and
selecting a predetermined number of visual items in an order of higher preferences in each of the classified sections.

4. The method of claim 2, wherein displaying the at least one visual item of the selected visual items comprises displaying a visual item located in a direction corresponding to the first input among the selected visual items.

5. The method of claim 2, wherein displaying the visual item of the at least one selected visual items comprises displaying a visual item located closest to a currently displayed visual item of the selected visual items.

6. The method of claim 1, wherein the preferences of the each of the plurality of individual visual items are calculated based on time periods for which the each of the plurality of respective visual items have been displayed.

7. The method of claim 1, wherein the preferences of the each of the plurality of visual items are calculated based on the numbers of times which the each of the plurality of visual items have been displayed.

8. The method of claim 1, wherein the preferences of the each of the plurality of visual items are calculated based on predetermined weights that have been allocated to the each of the plurality of visual items.

9. The method of claim 1, further comprising downloading the preferences of the each of the plurality of visual items before selecting the one or more visual items before selecting the one or more visual items.

10. The method of claim 9, wherein the downloaded preferences of the each of the plurality of visual items have been calculated by another electronic device.

11. An apparatus of displaying a visual item in an electronic device, the apparatus comprising:
an input unit configured to receive an input from a user;
a display unit configured to display a visual item; and
a controller configured to display, if a predetermined request is received, at least one visual item of a plurality of visual items, and to select, if a first input is received from a user, one or more visual items of the plurality of visual items based on preferences of each of the plurality of visual items and display at least one visual item of the selected visual items.

12. The apparatus of claim 11, wherein the controller is configured to select a predetermined number of visual items of the plurality of visual items in an order of higher preferences.

13. The apparatus of claim 11, wherein the controller is configured to classify the plurality of visual items into a predetermined number of sections, and to select a predetermined number of visual items in an order of higher preferences in each of the classified sections.

14. The apparatus of claim 12, wherein the controller is configured to display a visual item located in a direction corresponding to the first input of the selected visual items.

15. The apparatus of claim 12, wherein the controller is configured to display a visual item located closest to a currently displayed visual item of the selected visual items.

16. The apparatus of claim 11, wherein the preferences of the each of the plurality of visual items are calculated based on time periods for which the each of the plurality of visual items have been displayed.

17. The apparatus of claim 11, wherein the preferences of the each of the plurality of visual items are calculated based on the numbers of times which the each of the plurality of visual items have been displayed.

18. The apparatus of claim 11, wherein the preferences of the each of the plurality of visual items are calculated based on predetermined weights that have been allocated to the each of the plurality of visual items.

19. The apparatus of claim 11, further comprising a communication unit configured to communicate with a server,
wherein when the first input is received, the controller is configured to download the preferences of the each of the plurality of visual items from the server.

20. The apparatus of claim 19, wherein the downloaded preferences of the each of the plurality of visual items have been calculated by another electronic device.
